(19) United States
(12) Patent Application Publication
(10) Pub. No.: US 2025/0094851 A1
(43) Pub. Date: Mar. 20, 2025

(54) MULTI-CONSTRAINT QUBIT ALLOCATION METHOD AND QUANTUM APPARATUS USING THE SAME

(71) Applicant: POSTECH Research and Business Development Foundation, Pohang-si (KR)

(72) Inventors: Seok Hyeong KANG, Pohang-si (KR); Sung Hye PARK, Pohang-si (KR); Jae Yoon SIM, Pohang-si (KR); Do Hun KIM, Pohang-si (KR)

(73) Assignee: POSTECH Research and Business Development Foundation, Pohang-si (KR)

(21) Appl. No.: 18/542,385

(22) Filed: Dec. 15, 2023

(30) Foreign Application Priority Data
Sep. 19, 2023 (KR) 10-2023-0125128

(51) Int. Cl. G06N 10/40; G06N 10/70

(52) U.S. Cl. CPC G06N 10/40; G06N 10/70

(57) ABSTRACT

Disclosed is a multi-constraint qubit allocation method and a quantum apparatus using the same. The method comprises generating an interaction graph representing a quantum circuit on the basis of the number of two-qubit gates, determining edge weights between connected nodes in the interaction graph by introducing a fitting coefficient for a decay effect, searching for an isomorphic part, layout graph, between target hardware and the interaction graph by graph matching, and performing frequency matching for a layout graph by searching for frequency allocated to each location of qubits by limiting unidirectional movement on each of an x-axis and a y-axis of a hardware plane of the target hardware to a range from −1 to +1.

### CROSS-REFERENCE TO RELATED APPLICATIONS

This application claims priority to Korean Patent Application No. 10-2023-0125128, filed on Sep. 19, 2023, with the Korean Intellectual Property Office (KIPO), the entire contents of which are hereby incorporated by reference.

### BACKGROUND

### 1. Technical Field

Example embodiments of the present disclosure relate in general to a multi-constraint qubit allocation (MCQA) technology for scalable quantum apparatus, and more particularly, to an MCQA method of modifying an input circuit according to various hardware topology constraints and allocating qubits and a quantum apparatus employing the MCQA method.

### 2. Related Art

Quantum computing is rapidly advancing and expected to surpass classical computing. The latest quantum hardware employs various technologies, such as superconducting qubits, and has reached a level of several hundreds of qubits. However, as the name “noisy intermediate-scale quantum (NISQ)” represents, qubits are not fully controlled. In NISQ hardware, qubits are very sensitive to surroundings, and errors easily occur accordingly. Therefore, quantum error correction (QEC) is essential to fault-tolerant quantum computing (FTQC).

FTQC is a quantum computing paradigm based on the quantum threshold theorem. According to this theorem, when a physical error rate of quantum hardware is below a specific threshold value, it may be assumed that a logical error rate becomes zero by applying QEC. Accordingly, the key to entering the FTQC era is the implementation of QEC.

Surface code is the most promising QEC system and may tolerate a maximum physical error of 1%. Another advantage of surface code is high scalability. As long as unit cells are repeatedly stacked using a square lattice structure of surface code, massive quantum hardware may be easily built. Lately, there have been efforts to scale up quantum hardware using a structure optimized for surface code. Such a quantum hardware technology may be called the near-FTQC era in which quantum hardware is scalable but is not fully error-tolerant.

Various quantum software stacks need to be developed according to developing hardware trends. A representative problem in design automation of NISQ computing is qubit allocation or qubit mapping. Qubit allocation is a process of modifying a quantum circuit so that the quantum circuit can be run on target hardware. Quantum computations are performed by executing quantum logic gates which constitute a quantum circuit. In this operation, a two-qubit gate is executable only on connected physical qubits.

However, physical qubits constituting the latest superconducting quantum processor are only connected between the closest neighboring ones. Therefore, it is not possible to satisfy all connectivity constraints of quantum gates. To solve the problem of limited connectivity, according to existing methods, initial mapping is defined first between logical qubits constituting a quantum circuit and physical qubits constituting hardware. After that, in the main mapping phase, additional gates to be used are found through a heuristic search, and the gates are added in front of a gate that is not executed so that the problem of limited connectivity can be solved. However, the additional gates lead to an increase in the depth and errors of an output circuit. Therefore, the goal of qubit allocation is to effectively reduce the number of additional gates.

In near-FTQC, the problem of qubit allocation not only has hardware topology constraints but also other additional constraints.

First, it is necessary to consider shared control to operate qubit groups. To implement a scalable quantum process, near-FTQC controls groups of qubits rather than individual qubits. This is allowed by sharing classical control elements such as arbitrary waveform generators (AWGs). Since shared control has an influence on gate execution in the same frequency group, scheduling among qubits is necessary.

Second, it is also necessary to consider the latency of a final circuit. When an actual duration of gates is given, a reduction in the number of additional gates does not always mean a reduction in circuit execution time. Accordingly, an efficient method is necessary to maximize the number of gates that are executed in parallel during a unit time. To this end, a related technology employs resource-aware mapping for a scalable processor. According to this related technology, latency is reduced by scheduling a circuit and setting a critical path in the main mapping. However, an initial mapping methodology of this related technology is only focused on reducing gate overhead, and other hardware constraints are not taken into consideration.

Consequently, a new approach is necessary to resolve several constraints in the overall mapping phase.

### SUMMARY

Accordingly, example embodiments of the present disclosure are provided to substantially obviate one or more problems due to the limitations and disadvantages of the related art.

Example embodiments of the present disclosure provide a multi-constraint qubit allocation (MCQA) method in which not only a hardware topology but also actual constraints of near fault-tolerant quantum computing (FTQC) such as a frequency group, primitive gate set, and latency of circuits are taken into consideration.

Example embodiments of the present disclosure also provide an MCQA method for further reducing latency by achieving maximum parallelism while reducing the number of additional gates and a circuit latency and a quantum apparatus using the MCQA method.

According to an exemplary embodiment of the present disclosure, a multi-constraint qubit allocation (MCQA) method for a scalable quantum apparatus may comprise: generating an interaction graph representing a quantum circuit on the basis of the number of two-qubit gates; determining edge weights between connected nodes in the interaction graph by introducing a fitting coefficient for a decay effect; searching for an isomorphic part, layout graph, between the coupling graph of target hardware and the interaction graph by graph matching; and performing frequency matching for a layout graph by searching for frequency patterns allocated to each location of qubits by limiting unidirectional movement on each of an x-axis and a y-axis of a hardware plane of the target hardware to a range from −1 to +1.

The searching for the layout graph may comprise: repeatedly searching for physical locations of logical qubits of the interaction graph in descending order of edge weight.

The searching for the layout graph may comprise: repeatedly searching for physical locations of child nodes connected to a logical center node of a breadth-first search (BFS) queue.

The performing of the frequency matching may comprise: additionally considering a layout graph that is symmetrical to the layout graph about the y-axis of the hardware plane in a Cartesian coordinate system.

The performing of the frequency matching may comprise: calculating a frequency allocated to each location of qubits based on the frequency period by repeating the arrangement of each frequency pattern.

The MCQA method may further comprise: predicting a degree of parallelism of gates which are executable for all graphs obtained by searching for frequency patterns allocated to each location of qubits.

The MCQA method may further comprise: determining an order of gates to be executed in main mapping.

The determining of the order of the gates to be executed may comprise: determining the order of the gates to be executed using a qubit-based gate dependency list for the quantum circuit, the gate dependency list, having connection lists with the same number as logical qubits, may include indices of gates and durations of the gates, and the connection lists may represent topological relationships between gates in the corresponding qubits.

The MCQA method may further comprise, when at least one gate of the quantum circuit does not satisfy a connectivity constraint, adding a swap gate or a move gate in front of the gate not satisfying the connectivity constraint.

The MCQA method may further comprise: selecting a gate, either a swap gate or move gate, having a higher one of costs calculated for all candidate swap gate and move gates.

The MCQA may further comprise, when at least one gate of the quantum circuit does not satisfy the connectivity constraint, converting the gate not satisfying the connectivity constraint into a bridge gate. The bridge gate may have a physical distance of 2.

The MCQA method may further comprise: determining whether scheduled gates in the quantum circuit including the gates of which the order is determined are executable in a current time-step.

The MCQA method may further comprise, when a frozen duration (FD) flag introduced to each logical qubit is 0, indicating that the corresponding qubit is not currently executing any scheduled gates, processing the corresponding qubit as the current scheduled gate, allowing it to proceed to the next gate execution.

The MCQA method may further comprise giving relatively high priority to two-qubit gates among the scheduled gates.

The MCQA method may further comprise giving relatively high priority to a gate having the longest critical path among the same type of gates in the scheduled gates.

The MCQA method may further comprise: initializing frozen frequency (FF) flags introduced for physical qubits of quantum hardware to −1 and updating the FF flags according to frequency states.

The MCQA method may further comprise: scheduling a two-qubit gate which is selected according to the priority of the FD flags, according to preset frequency adjustment rules.

The scheduling of the single-qubit gate may comprise: recording a first gate type of each frequency group and updating the FF flags for all qubits belonging to the same frequency group; comparing subsequent gates with the previously recorded gate type to determine whether the subsequent gates are of the previously recorded gate type and whether the FF flags are correctly set; and scheduling only executable gates according to determination results.

The MCQA may further comprise, before the generating of the interaction graph on the basis of the number of two-qubit gates, pre-processing an input circuit, or after the main mapping, post-processing main mapping outcome circuits.

The pre-processing of the input or the post-processing of the main mapping outcome circuits may comprise: converting two rotation operators applied to single qubits having different signs about the same axis of the Bloch sphere into an identity gate or replacing consecutive with a single rotation operator in which a sum of angles of gates forms a new angle.

According to the present disclosure, it is possible to generate an initial mapping for reducing the number of additional gates and latency together in a rapid runtime through frequency-aware graph matching in qubit allocation.

According to the present disclosure, dynamic scheduling is used for achieving the maximum parallelism of gate execution in the main mapping phase, and the latency of the final circuit can be further reduced accordingly.

According to the present disclosure, it is possible to reduce the number of additional CZ gates by 58%, the latency by 28%, and runtime by 99% or more compared to a related near-FTQC methodology.

According to the present disclosure, the time complexity of a heuristic methodology of the present embodiment is linearly proportional to the number of gates. Accordingly, the heuristic methodology can be expected to show high scalability for a full FTQC device.

### BRIEF DESCRIPTION OF DRAWINGS

FIG. 1A is a diagram illustrating a near-FTQC hardware topology for a surface code-17 processor.

FIG. 1B is a diagram illustrating the frequency constraints of a single-qubit gate of a quantum processor having the near-FTQC hardware topology.

FIGS. 2A to 2D are diagrams of gates that may be employed by near-FTQC processors, decomposed with a primitive gate set (RX, RY, and CZ).

FIGS. 3A to 3C are diagrams illustrating frequency constraints for two-qubit gate execution of near-FTQC hardware.

FIG. 4 is a flowchart illustrating an MCQA method according to an example embodiment of the present invention.

FIG. 5 is a flowchart of a detailed process that may be employed in the initial mapping of the MCQA method of FIG. 4.

FIG. 6 is a flowchart of a detailed process that may be employed in the main mapping of the MCQA method of FIG. 4.

FIG. 7 is a diagram illustrating an algorithm describing a frequency-aware graph-matching process that may be employed in the initial mapping of the MCQA method of FIG. 4.

FIG. 8 is a diagram illustrating a quantum circuit to which the MCQA method of FIG. 4 will be applied.

FIGS. 9A to 9C are diagrams illustrating an initial mapping process of a quantum circuit.

FIG. 10A to 10C are diagrams illustrating a frequency-matching process for generating the frequency-matched layout graph of FIG. 9C.

FIG. 11 is a diagram illustrating a process of predicting the degree of parallelism of gates that are executable for all graphs obtained through a frequency search on the layout graph of FIG. 9B.

FIG. 12 shows an algorithm illustrating a dynamic scheduling-based main mapping algorithm that may be employed in the main mapping of the MCQA method of FIG. 4.

FIG. 13 is a diagram illustrating a qubit-based gate dependency list (Glist) for the quantum circuit of FIG. 8 that is applicable to a dynamic scheduling-based main mapping of FIG. 12.

FIGS. 14A to 14C are diagrams illustrating gates in target hardware for resolving the connectivity constraint that may be employed in the main mapping of the qubit allocation method of FIG. 4.

FIGS. 15A and 15B show a scheduling algorithm for dynamic scheduling that may be employed in the main mapping of the qubit allocation method of FIG. 4.

FIG. 16 is a diagram illustrating a duration scheduling process that may be employed in the main mapping of the qubit allocation method of FIG. 4.

FIG. 17 is a diagram illustrating a frequency scheduling process that may be employed in the main mapping of the qubit allocation method of FIG. 4.

FIG. 18 is a diagram illustrating a quantum circuit optimization (QCO) module that may be employed in the pre- and post-processing phase of the qubit allocation method of FIG. 4.

FIG. 19 is a graph showing mapping overhead comparison results between the qubit allocation method of the present embodiment and a comparative example Qmap.

FIG. 20 is a graph showing runtime performance comparison results between the qubit allocation method of the present embodiment and the comparative example.

FIG. 21 is a table showing mapping overhead and runtime values of comparative experiment results of FIGS. 19 and 20.

FIG. 22 is a schematic block diagram of a quantum apparatus employing a qubit allocation method according to another example embodiment of the present invention.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

First, the theoretical background of the present disclosure will be briefly described below.

Surface code is a representative quantum error correction (QEC) scheme that runs on a square lattice structure. Among several surface codes, surface code-17 employs 17 physical qubits for one logical qubit. Running a practical quantum algorithm on a QEC processor requires at least 1,000 physical qubits. Accordingly, it is necessary to design a scalable quantum processor.

To this end, according to some related technologies, space is multiplexed using a fixed frequency array, and thereby the complexity of hardware control is reduced. In this case, eight qubit unit cells based on a frequency pattern may be defined, and then large-scale surface code may be implemented by repeating the defined cells. However, a current quantum hardware design technique is insufficient to implement a sufficient number of logical qubits for full FTQC. Accordingly, in a current state where hardware has not yet reached the full FTQC stage, the present disclosure defines a scalable processor as near-FTQC hardware.

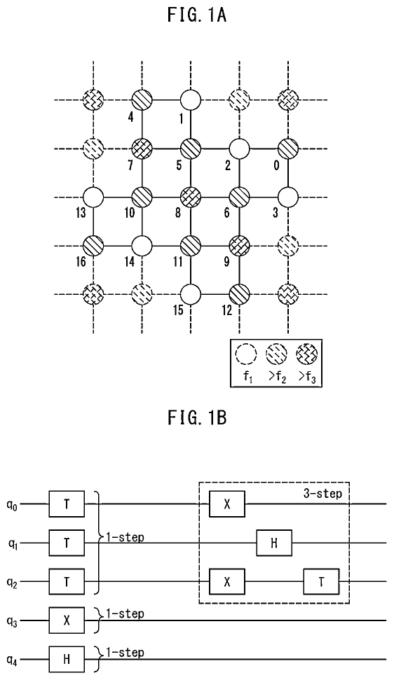

FIG. 1A is a diagram illustrating a near-FTQC hardware topology for surface code-17. FIG. 1B is a diagram illustrating the frequency constraints of a single-qubit gate of a quantum processor having the near-FTQC hardware topology.

A surface code-17 processor of the near-FTQC era shown in FIG. 1A may be expressed using classical control elements shared in the same frequency group. Qubits controlled as classical control elements are displayed in the same style, and the frequency relationships between qubits are f₁>f₂>f₃.

As shown in FIG. 1B, the state of qubits q₀, q₁, q₂, q₃, and q₄ may be converted by a combined circuit of single-qubit gates, such as a Hadamard gate H, Toffoli gate T, and an X gate X, and two-qubit gate, such as controlled-NOT gate CNOT.

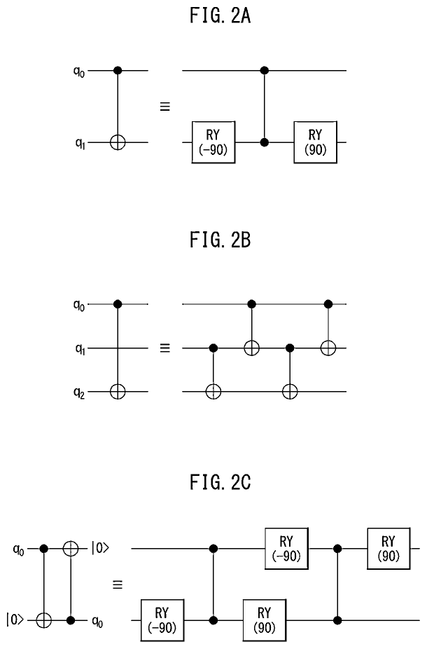

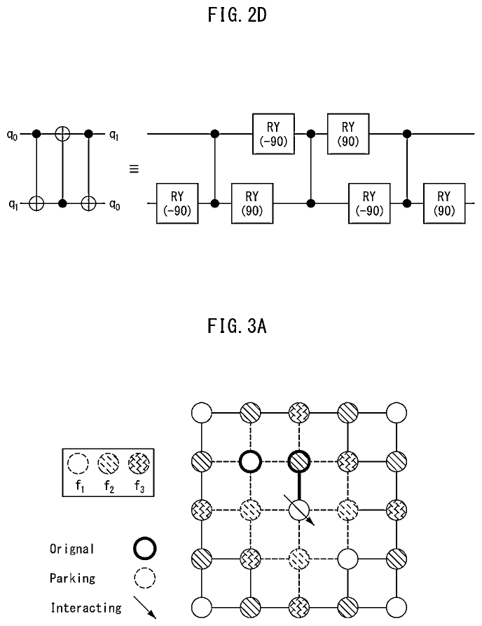

Next, multiple constraints in qubit allocation will be described, focusing on the surface code-17 processor. FIGS. 2A to 2D are diagrams of gates that may be employed by near-FTQC processors, decomposed with a primitive gate set (RX, RY, and CZ).

As shown in FIGS. 2A to 2D, gates for resolving a connectivity constraint of two-qubit gates that are usable in the present embodiment, representatively, controlled-NOT (CNOT) gates (see FIG. 2A), may include a bridge gate (see FIG. 2B), a move gate (see FIG. 2C), and a swap gate (see FIG. 2D). Each gate may be decomposed into primitive gate sets.

In other words, as the surface code-17 processor, only adjacent physical qubits are connected. A coupling graph of the surface code-17 processor (see FIG. 1A) shows the relationship between physical qubits. Here, the execution of two-qubit gates of FIGS. 2A to 2D on corresponding hardware is allowed only when two qubits constituting the gates are mapped on connected hardware. In other words, when a non-adjacent two-qubit gate is executed, the connectivity constraint is violated.

In a qubit allocation method of the present embodiment, three types of gates, a swap gate, a move gate, and a bridge gate, are used to satisfy the connectivity constraint. All quantum gates are expressed as a combination of single-qubit gates and two-qubit gates. However, it is not easy to predefine all types of gates in a quantum processor. Therefore, in the qubit allocation method of the present embodiment, quantum gates decomposed into primitive gate sets are used.

Examples of gates decomposed into primitive gate sets are shown in FIGS. 2A to 2D. In other words, as shown in FIGS. 2A to 2D, single-qubit gates in primitive gate sets include an RX gate and an RY gate that rotate the qubit state around the x-axis and the y-axis, respectively. A two-qubit gate includes only a controlled-Z (CZ) gate that performs a controlled phase shift. Considering the actual operations of gates, the duration of RX and RY gates is defined as one cycle, and the duration of CZ gates is defined as two cycles. Here, one cycle may correspond to 20 ns.

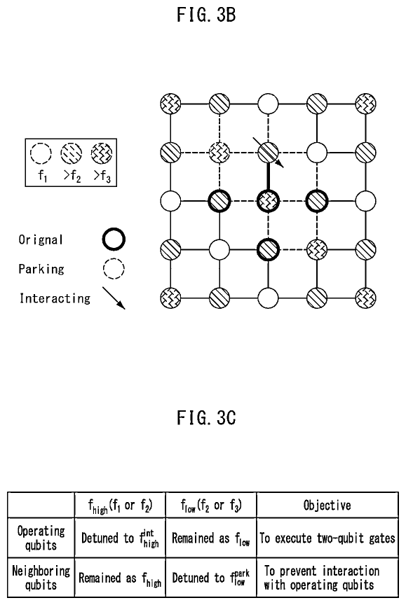

FIGS. 3A to 3C are diagrams illustrating frequency constraints of near-FTQC hardware. FIG. 3A illustrates execution of a two-qubit gate that operates between a first frequency f₁ and a second frequency f₂, and FIG. 3B illustrates the execution of a two-qubit gate that operates between the second frequency f₂ and a third frequency f₃. FIG. 3C shows frequency adjustment rules for the first frequency f₁ to the third frequency f₃.

In FIGS. 3A to 3B, thick lines indicate two-qubit gates that are being executed, and dashed lines indicate coupling edges of which nodes are not simultaneously executable. As seen in FIG. 3C, level relationships between frequencies are f₁>f₁^{int}>f₂>f₂^{park}>f₂^{int}>f₃>f₃^{park}.

A scalable quantum processor employs shared classical control elements to control and measure several qubits. In the surface code-17 processor (see FIG. 1A), qubits are controlled using three frequency groups (f₁>f₂>f₃). Since qubits in the same frequency group f₁, f₂, and f₃ do not independently operate, the execution of a quantum gate has the following constraints.

In other words, a single-qubit gate is implemented by microwave pulses using a microwave source or arbitrary waveform generator (AWG). In the qubit allocation method of the present disclosure, it is assumed that the same microwave source controls all qubits belonging to the same frequency group. Accordingly, a gate pulse used for operating qubits belonging to the same frequency group may operate only one type of qubits in one unit time. Therefore, several time steps are necessary to execute different types of single-qubit gates in the same frequency group (see FIG. 1B).

FIGS. 3A to 3C show that two-qubit gates are executed on pairs of qubits having different frequencies. Here, when one qubit in a pair of qubits has a higher frequency f_{high} (f₁ or f₂), the other qubit has a lower frequency f_{low} (f₂ or f₃). To implement a two-qubit gate using a microwave pulse, f_{high} is detuned to an interacting frequency f_{high} and approaches f_{low}. Also, f_{low} is maintained at its original frequency. Here, it is necessary to prevent interaction between a pair of qubits that operate the two-qubit gate and neighboring qubits. Accordingly, additional frequency adjustment is necessary. Also, a neighboring qubit having f_{high} is maintained at the frequency, and a neighboring qubit having f_{low} is detuned to a parking frequency f_{low}^{int}. The purpose of qubit allocation in consideration of these constraints is to maximize the parallelism of gate execution in each time step.

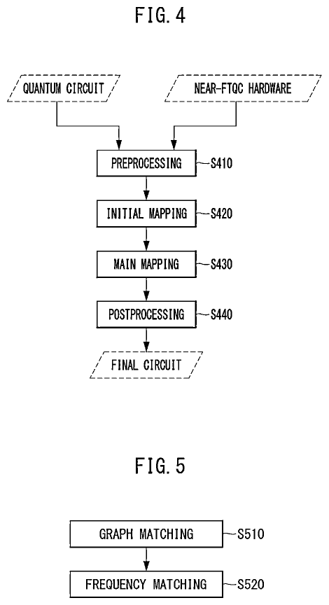

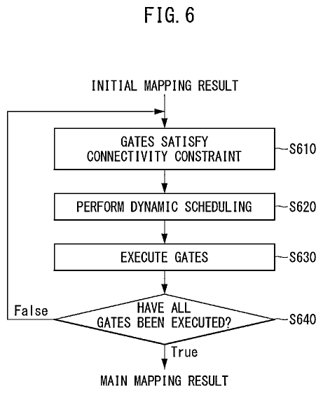

FIG. 4 is a flowchart illustrating an MCQA method according to an example embodiment of the present invention. FIG. 5 is a flowchart of a detailed process that may be employed in the initial mapping of the MCQA method of FIG. 4. FIG. 6 is a flowchart of a detailed process that may be employed in the main mapping of the MCQA method of FIG. 4.

Referring to FIG. 4, the MCQA method may basically include two steps, initial mapping and main mapping. The initial mapping may be based on frequency-aware graph matching, and the main mapping may be based on dynamic scheduling.

The MCQA method may be configured to selectively preprocess inputs to a quantum circuit and near-FTQC hardware (S410), perform initial mapping (S420), perform main mapping on the initial mapping results (S430), selectively postprocess the main mapping results (S440), and then obtain a final circuit through the results.

The MCQA method comprises a process for qubit allocation in hardware, controlling some groups of qubits simultaneously using frequency sharing.

Further, as shown in FIG. 5, the initial mapping phase may include a phase of performing graph matching (S510) and a phase of performing frequency matching (S520).

Furthermore, as shown in FIG. 6, the main mapping phase may be configured to receive initial mapping results, make gates that are executed in the current turn to satisfy the connectivity constraint (S610), perform dynamic scheduling on the gates (S620), execute gates of a circuit according to the dynamic scheduling (S630), determine whether all gates of the circuit have been executed (S640), and obtain main mapping results after the foregoing process is performed on all the gates of the circuit.

Below, a process of rapidly performing initial mapping while minimizing additional gates and a circuit latency according to Algorithm 1 of the present embodiment will first be described.

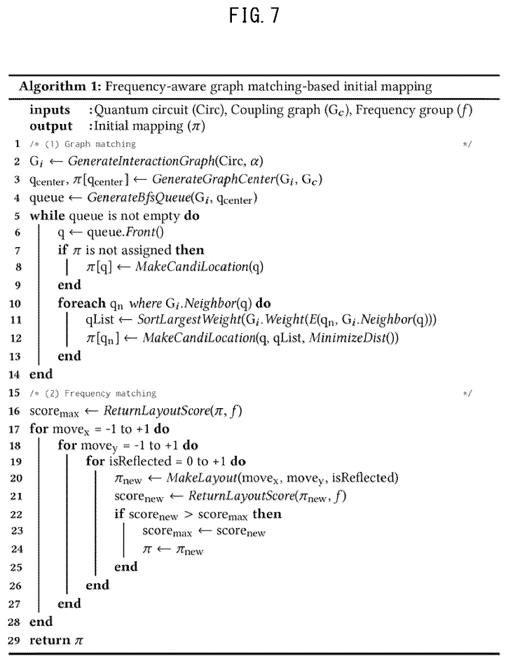

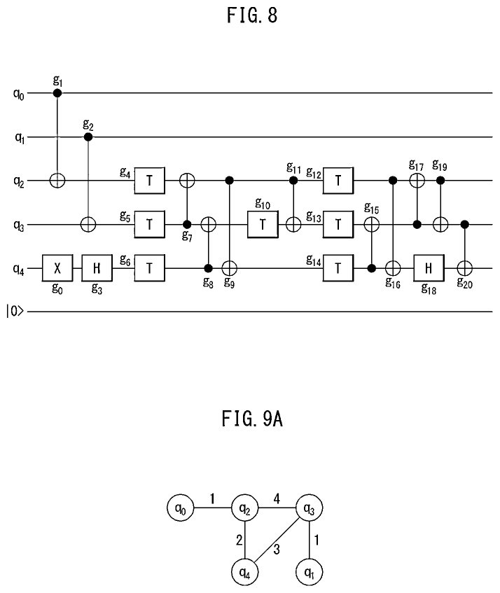

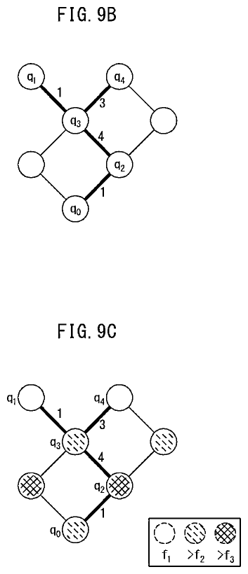

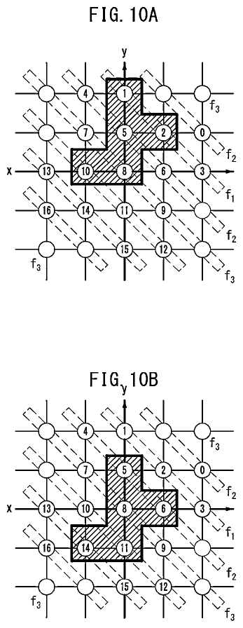

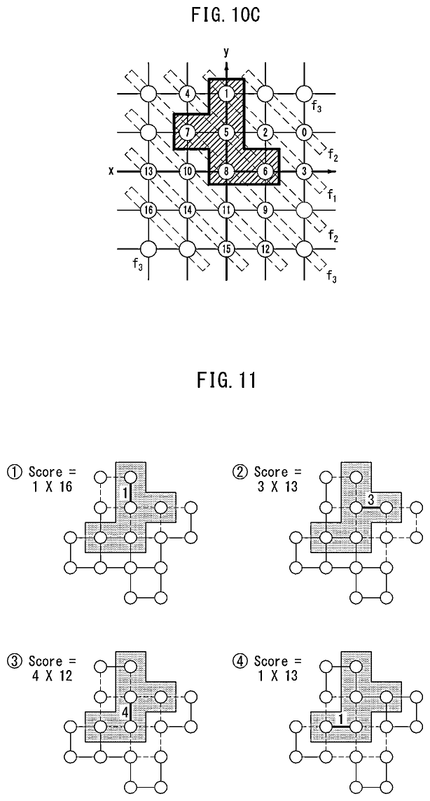

FIG. 7 shows an algorithm illustrating a frequency-aware graph-matching process that may be employed in the initial mapping of the MCQA method of FIG. 4. FIG. 8 is a diagram illustrating a quantum circuit to which the MCQA method of FIG. 4 will be applied. FIGS. 9A to 9C are diagrams illustrating an initial mapping process of a quantum circuit. FIGS. 10A to 10C are diagrams illustrating a frequency-matching process for generating the frequency-matched layout graph of FIG. 9C. FIG. 11 is a diagram illustrating a process of predicting the degree of parallelism of gates that are executable for all graphs obtained through a frequency search on the layout graph of FIG. 9B.

Referring to FIG. 7, in the first phase of frequency-aware graph matching-based initial mapping in Algorithm 1, a qubit allocation device searches for initial mapping that positions qubit pairs of two-qubit gates as close as possible (Lines 1 to 14). For example, when the quantum circuit illustrated in FIG. 8 is represented as the interaction graph in FIG. 9A, a layout graph obtained by applying such a graph matching process to FIG. 1A may be the example shown in FIG. 9B.

Subsequently, to reduce the latency of a final circuit, the qubit allocation device determines an optimal frequency pattern for the layout graph (Lines 15 to 28). A process of searching for an optimized frequency pattern for the layout graph is illustrated in FIGS. 10A to 10C, and an initial mapping result obtained in this way is illustrated in FIG. 9C.

In other words, FIG. 9A shows an interaction graph for the quantum circuit of FIG. 8, and FIG. 9B shows a layout graph which is a graph-matching result of surface code-17. FIG. 9C shows a result of searching for an optimized frequency pattern for the layout graph, that is, a frequency matching result.

In a related initial mapping methodology, the most appropriate initial mapping solution for reducing the number of additional gates is to find a part of the target hardware having the same shape as an interaction graph of a quantum circuit. The present disclosure partially employs this related initial mapping methodology. In other words, the qubit allocation method of the present embodiment may employ an interaction graph Gᵢ as shown in FIG. 9A. The interaction graph may include nodes (N) q₀, q₁, q₂, q₃, and q₄ each representing a logical qubit, and edges (E) representing two-qubit gates between two nodes.

In FIGS. 9A to 9C and (1) to 4) of FIG. 11, numbers on lines connecting adjacent lines represent edge weights. In FIGS. 10A to 10C and FIG. 11, shaded parts represent layout graphs.

According to the qubit allocation method of the present embodiment, edge weights may be set as shown in Equation 1 below to represent global and local features of a quantum circuit.

$${G}_{i} \cdot Weight ( E ( {q}_{c} , {q}_{t} ) ) = {\sum }_{i = 0}^{k - 1} {a}^{i} \cdot \# {CZ}_{i} \cdot ( {q}_{c} , {q}_{t} ) ( 0 < α \leq 1 ) \qquad [ Equation l ]$$

In Equation 1, q_{c} and qₜ are the control qubit and the target qubit of a two-qubit gate g, respectively. Here, k is the number of stages into which the overall circuit is divided. #CZᵢ is the number of CZ gates in an i^{th} circuit stage, and a is a constant introduced for decay.

According to the qubit allocation method of the present embodiment, it is possible to minimize connectivity problems occurring in the front part of a circuit by considering the overall circuit including the front part.

In describing the qubit allocation method of the present embodiment, a sign: π:q→Q represents the initial mapping from a set of logical qubits q to a set of physical qubits Q. When a logical qubit is allocated to no physical qubit, π may be set to −1.

According to the qubit allocation method of the present embodiment, to reduce the complexity of a graph matching search, the center of an interaction graph is mapped to the center of a coupling graph which represents hardware as shown in the second and third lines (Lines 2 and 3) of Algorithm 1.

After that, a breadth-first search (BFS) is performed to determine a graph-matching order (see Line 4). In graph matching, physical locations for the front node of a BFS queue (see Lines 6 to 9) and for child nodes connected to a corresponding logical node (see Lines 10 to 13) are repeatedly searched for. A physical location candidate for each logical center may be generated using the location of a node interacting with the center as a reference node. Also, a node having the largest weight may be selected in the coupling graph. Physical location candidates for child nodes qₙ may be generated using interaction between nodes.

According to the qubit allocation method, first, an adjacent qubit list qList in which adjacent qubits are sorted by highest edge weight for the child nodes qₙ is generated. After that, only physical nodes that may minimize the distances between the child nodes qₙ and the qubit list qList are left at candidate locations. The above process is repeated until all logical qubits (see FIG. 9B) constituting the circuit have unique physical locations, and a finally generated layout graph is obtained. The obtained graph is used in a frequency pattern search which is the next phase.

FIGS. 10A to 10C are diagrams illustrating a frequency-matching process for generating the frequency-matched layout graph of FIG. 9C. Here, FIG. 10A shows that the layout graph of a comparative example is located at the center of a surface code-17 processor, FIG. 10B shows a case where the layout graph of FIG. 10A is moved down by one node, and FIG. 10C shows a case where the layout graph of FIG. 10A is symmetrically inverted about the y-axis. The frequency matching process is referred to as a frequency pattern searching process.

The purpose of a frequency pattern search, that is, frequency matching, is to increase the probability of parallel execution between gates when a layout graph is used. The qubit allocation method of the present embodiment may be configured to reduce search space by analyzing the surface code-17 processor first.

Surface code may be located on a Cartesian coordinate system using the center of physical qubits as the origin of the Cartesian coordinate system. In the processor, each frequency pattern is repeated at periods of 4, and the number of frequency groups may be three. A period of 4 may be expressed as F={f₃, f₂, f₁, f₂}. Here, a node of which the sum of an x coordinate and a y coordinate is zero has a frequency f₃. In the case of x+y=1 where a node is moved right by one node on the x-axis or moved up by one node on the y-axis, the node of x+y=1 has a frequency of f₂. In the case of x+y=2, where is additionally moved from x+y=1, the node of x+y=2 has a frequency of f₁. Finally, a node of x+y=3 has a frequency of f₂ again. That is, a node of x+y=4 has a frequency of f₃ again. For reference, when the node is moved left by one node on the x-axis or moved down by one node on the y-axis, x+y=−1. In this way, frequencies allocated to all physical qubits may be calculated according to Equation 2 below.

$$i ≡ ( x + y ) mod 4 ⇒ f ( x , y ) = F [ i ] , ( F = \{ {f}_{3} , {f}_{2} , {f}_{1} , {f}_{2} \} ) \qquad [ Equation 2 ]$$

According to the qubit allocation method of the present embodiment, all possible frequency patterns are searched for on the basis of the foregoing analysis using only a small number of movements and symmetrization. FIGS. 10A to 10C illustrate a frequency pattern search. When a hardware plane is large, all frequency patterns may be searched for using only unidirectional movement, but the surface code-17 processor has a limitation. Therefore, to efficiently search for frequency patterns, the qubit allocation device performs bidirectional movement on each of the x-axis and the y-axis but limits the movement to a range from −1 to 1. Also, to thoroughly search for frequency patterns, the y-axis symmetry of a layout graph is also taken into consideration. After that, the degrees of gate parallelism which are possible for all graphs obtained through the frequency search are predicted, and optimal initial mapping may be selected.

Meanwhile, when the hardware plane of the target hardware is larger than the surface code-17 by a certain size or more, to efficiently search for frequency patterns, the qubit allocation device may perform unidirectional movement on each of the x-axis and the y-axis but extend the movement to a range from −3 to 3.

The degree of gate parallelism may be expressed as a corresponding score Score [Gₗ] as shown in Equation 3.

$$Score [ {G}_{i} ] = {\sum }_{{e}_{l} ∈ {G}_{l}} {\sum }_{e ∈ {E}_{p} [ e l ]} {G}_{i} \cdot Weight ( E ( e ↦ {q}_{s} , e ↦ {q}_{d} ) ) \qquad [ Equation 3 ]$$

In Equation 3, Gₗ and eₗ are candidate layout graphs, and all edge sets correspond to the candidate layout graphs, respectively. E_{P}[el] is a set of edges that may be executed in parallel when e₁ is executed. qₛ and q_{d} represent a source qubit and a destination qubit, respectively. After all frequency pattern searches (see FIGS. 10A to 10C) are finished, a frequency-aware graph having the highest score may be converted (see FIG. 9C).

Second, in the case of resolving a connectivity violation according to Algorithm 2 of the present embodiment, a process of achieving maximum parallelism between gates will be described below.

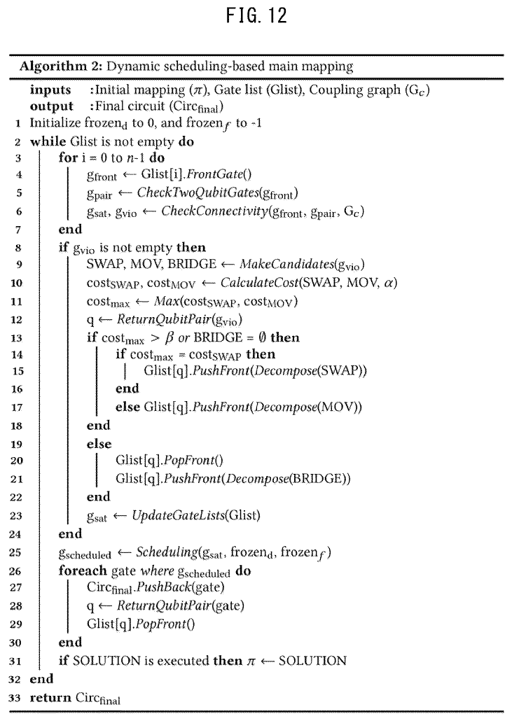

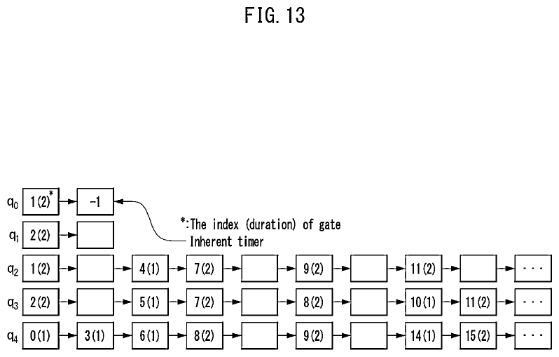

FIG. 12 shows an algorithm illustrating a dynamic scheduling-based main mapping algorithm that may be employed in the main mapping of the MCQA method of FIG. 4. FIG. 13 is a diagram illustrating a qubit-based gate dependency list Glist for the quantum circuit of FIG. 8 that is applicable to the dynamic scheduling-based main mapping of FIG. 12.

Referring to FIG. 12, Algorithm 2 relates to dynamic scheduling-based main mapping, and the purpose of the main mapping is to return a modified circuit in which all gates are executable by resolving constraints.

In the first phase of main mapping, the qubit allocation device determines the order of gates to be executed in main mapping (see Lines 3 to 7). As shown in FIG. 13, this phase may employ the qubit-based gate dependency list Glist for the quantum circuit of FIG. 8. In the gate dependency list Glist, the indices of gates are shown in quadrangular boxes, and the duration of each gate is shown in parentheses. To intuitively check durations in the gate dependency list Glist, an inherent timer with an index of −1 may be connected to the back of a two-qubit gate.

Referring back to FIG. 12, in the next phase of the qubit allocation method, when a gate gᵥᵢₒ does not satisfy the connectivity constraint, a swap gate or a move gate may be added, or a constrained gate may be changed to a bridge gate (see Lines 8 to 24). In this case, the connectivity problem can be solved.

After that, gates that are dynamically scheduled to reduce a circuit latency may be executed (see Lines 25 to 31). This phase may employ Algorithm 3 to be described below.

As described above, to determine a gate execution order, the qubit allocation device may generate the qubit-based gate dependency list Glist as shown in FIG. 13. The gate dependency list includes n connection lists which have the same number as logical qubits, and each list may represent the topological relationship between gates in a corresponding qubit.

Gates may be sorted through the following procedure. A front gate g_{front} is defined for each qubit, and it may be determined whether all gates in front of a corresponding gate have been executed. In the case of a single-qubit gate, the front gate g_{front} is currently in an executable turn. On the other hand, a two-qubit gate is required to be a pair gate gₚₐᵢᵣ in which the pair of qubits is a front gate. To execute the pair gate gₚₐᵢᵣ in a current layout, the pair of logical qubits of the pair gate gₚₐᵢᵣ is required to satisfy the connectivity constraint (gₛₐₜ). Otherwise, the gate is defined as a gate gᵥᵢₒ that violates the connectivity constraint. In this way, according to the present embodiment, the qubit allocation method is configured to resolve the connectivity constraint for all gates in a circuit.

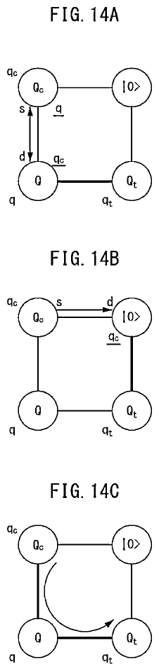

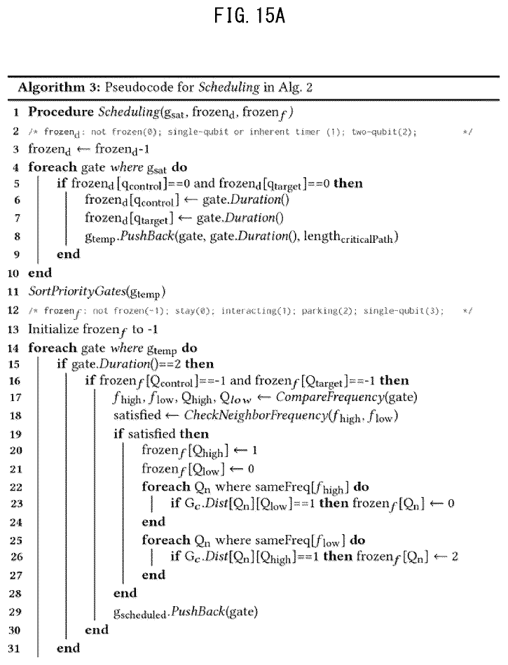

FIGS. 14A to 14C are diagrams illustrating gates in target hardware for resolving the connectivity constraint that may be employed in the main mapping of the qubit allocation method of FIG. 4.

FIGS. 14A to 14C show gates used for resolving a connectivity violation of a two-qubit gate q_{c} and qₜ. FIG. 14A shows an operation of a swap gate, FIG. 14B shows an operation of a move gate, and FIG. 14C shows an operation of a bridge gate. Hardware qubits depicted with small q are shown in FIGS. 14A to 14C have logical qubits with data, and hardware qubits containing the |0>are auxiliary qubits without data. Also, underlined qubits q and qₜ represent the changed qubits after the swap or move operation, and arrows represent the movement of qubits after the application of each gate. Thick lines represent that the connectivity constraint is satisfied.

As described above, in the qubit allocation method of the present embodiment, connectivity violation problems can be solved using swap, move, and bridge gates. In other words, in the main mapping phase of the qubit allocation method, the distance between a pair of qubits of the gate gᵥᵢₒ that violates the connectivity constraint can be reduced by 1 using a swap gate and a move gate. Therefore, when a swap gate or a move gate is executed, a current layout is changed. Here, the swap gate exchanges the location of a pair of logical qubits with data on a coupling graph. The move gate is similar to the swap gate but moves a data qubit to an auxiliary qubit without data. The layout corresponding to the initial mapping predefined in the previous operation may be changed using the move gate. Also, three CNOT gates are required in total for using the swap gate, whereas the move gate requires only two CNOT gates.

A gate for effectively solving the foregoing connectivity violation problem may be determined using a cost function.

Before the cost function is calculated, pairs of neighboring qubits that are closest to a control qubit or a target qubit of the gate gᵥᵢₒ that violates the connectivity constraint may be generated as a candidate list for the swap gate or the move gate.

After that, the qubit allocation device may calculate the cost function for each candidate gate using the following two equations.

$$Gain ( g ) = {G}_{c} \cdot Dist [ {Q}_{c}^{π} ] [ {Q}_{t}^{π} ] - {G}_{c} \cdot Dist [ {Q}_{c}^{{π}_{new}} ] [ {Q}_{t}^{{π}_{new}} ] \qquad [ Equation 4 ]$$

In Equation 4, Q_{c} and Qₜ are physical locations of a control qubit and a target qubit of a two-qubit gate g, and π and π_{new} are the original layout and the modified layout after the swap gate or the move gate is added.

Therefore, when the swap gate or the move gate reduces the distance of the two-qubit gate, the qubit allocation device may be set to obtain a positive (+) gain through Equation 4.

$$Cost ( {Q}_{s} , {Q}_{t} ) = {\sum }_{q ∈ \{ {q}_{s} , {q}_{d} \}} {\sum }_{g ∈ Glist [ q ]} {α}^{Glist . Δ index [ {g}_{f} ] [ g ]} \cdot Gain ( g ) \qquad [ Equation 5 ]$$

In Equation 5, s and d are sources and destinations of the swap gate and the move gate, gf is a first two-qubit gate of which the connectivity constraint will be resolved by the swap gate or the move gate, and g is a following gate of an s or d qubit line. Δindex is the distance between gf and g in the gate dependency list Glist.

When the swap gate or the move gate consecutively resolves the constraints of the following gate, Equation 5 may return a higher cost.

According to Equations 4 and 5 described above, the qubit allocation method may select a gate having the highest cost.

Also, to avoid excessive change of the layout, the qubit allocation method may employ a bridge gate. The bridge gate does not directly reduce a physical distance but is converted into a set of adjacent CNOT gates of which qubit pairs have a physical distance of 1. Therefore, the bridge gate may be used to satisfy constraints without changing the layout.

In the present embodiment, the connectivity constraint can be resolved using only a bridge gate having a physical distance of 2. Since a CNOT gate having a physical distance of 2 is decomposed into four adjacent CNOT gates, the number of additional CNOT gates may be adjusted to three like the swap gates.

When the cost of the swap gate or the move gate selected through Equation 5 is not higher than the lower bound B, the qubit allocation device may satisfy constraints using a bridge gate. Also, the latency of an actual circuit may be taken into consideration by adding a gate decomposed into primitive gate sets to the foremost part of the gate dependency list Glist.

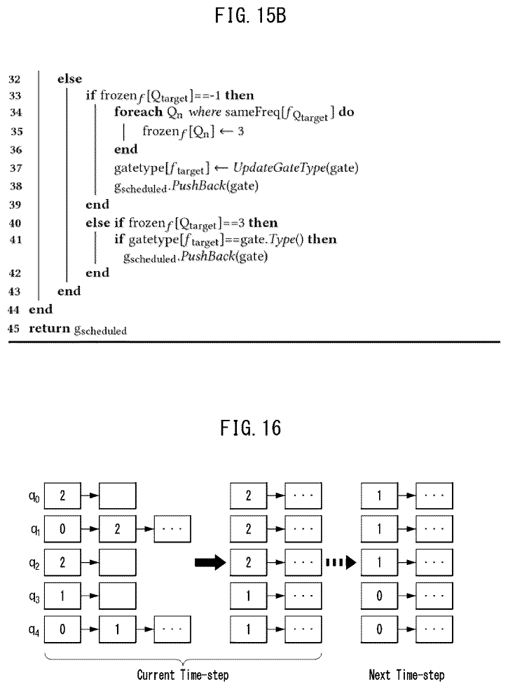

FIGS. 15A and 15B show a scheduling algorithm for dynamic scheduling that may be employed in the main mapping of the qubit allocation method of FIG. 4.

Referring to FIGS. 15A and 15B, dynamic scheduling includes two phases, which may be expressed as Algorithm 3. The two phases are a duration scheduling phase and a frequency scheduling phase. Dynamic scheduling may be performed by the qubit allocation device or a qubit control device including the qubit allocation device.

First, in the duration scheduling phase, the gate gₛₐₜ which satisfies the connectivity constraint is executable in a current time-step. To this end, the qubit allocation device may introduce a frozen duration (FD) flag frozena for each logical qubit. When the FD flag frozena is 0, the corresponding qubit may be considered as not executing any gate. Therefore, the qubit allocation device may perform duration scheduling only when both FD flags for a control qubit and a target qubit are 0.

After that, the qubit allocation device may give a higher priority to a two-qubit gate that requires a longer time for an operation. Among the same types of gates, one with the longest critical path has priority. When the duration scheduling ends, only gates gₜₑₘₚ without temporal constraints are left as gates to be executed.

Subsequently, in the frequency scheduling phase for the gates gₜₑₘₚ without temporal constraints, the qubit allocation device may use frozen frequency (FF) flags frozen_{f} for physical qubits in a manner similar to duration scheduling.

Subsequently, the qubit allocation device may initialize all FF flags frozen, to −1 and update flags according to the state. Two-qubit gates may be scheduled according to the priority of the gates gₜₑₘₚ without temporal constraints using frequency adjustment rules (see FIG. 3C).

Subsequently, the qubit allocation device may execute a two-qubit gate only when the FF flag frozen, of an operating qubit is 0 or 1 and all neighboring qubits satisfy frequency constraints. Here, when the FF flag is 0, a corresponding qubit has the lower frequency f_{low}, and when the FF flag is 1, a corresponding qubit has the higher frequency f_{high}. When a frequency violation occurs due to a previously scheduled qubit, the corresponding gate is not schedulable in this time step. In the case of a single-qubit gate, only the same type of gates are executable in the same frequency group. Accordingly, the qubit allocation device may record a first gate type in each frequency group and update the FF flag frozen_{f} for all qubits belonging to the same frequency group.

After that, the qubit allocation device may compare subsequent gates with the previously recorded gate type to determine whether the subsequent gates are of the recorded gate type and whether FF flags frozen, are correctly set, and then schedule only executable gates.

When the entire process of Algorithm 3 is completed, the qubit allocation device may return a scheduled gate g_{scheduled} that satisfies all constraints. When all gates are executed through the corresponding method, the qubit allocation device may return a final circuit.

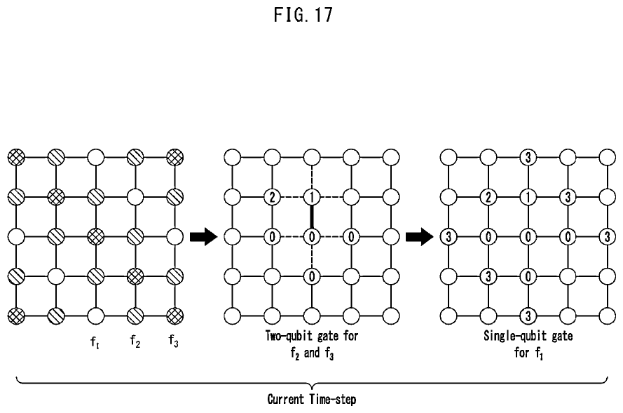

FIG. 16 is a diagram illustrating a duration scheduling process that may be employed in the main mapping of the qubit allocation method of FIG. 4. FIG. 17 is a diagram illustrating a frequency-scheduling process that may be employed in the main mapping of the qubit allocation method of FIG. 4.

According to the main mapping phase of the qubit allocation method of the present embodiment, in a dynamic scheduling process of arranging gates every time, the priority order of gates to be executed may be determined in consideration of the durations of a primitive gate set and each gate. The purpose of such scheduling is to maximize the parallelism of gates. A dynamic scheduling process may include a duration scheduling process and a frequency scheduling process.

In FIG. 16, numbers in boxes of qubits q₀, q₁, q₂, q₃, and q₄ represent frozen flags. Further, 0 represents “not frozen,” 1 represents an inherent timer or “single-qubit gate”, and 2 represents a “Two-qubit gate”.

As shown in FIG. 16, in the duration scheduling process, the qubit allocation device determines whether a gate is executable in a current time step. In the duration scheduling process, the qubit allocation device uses a frozen flag (hereinafter “duration flag”) representing a gate duration for each logical qubit. Also, the qubit allocation device reduces the duration flag in each operation being performed. Therefore, the corresponding qubit may be scheduled to be executed without time collision only when the flag is 0.

Subsequently, in the frequency scheduling process, the qubit allocation device determines whether the gate satisfies frequency constraints as shown in FIG. 17. In the surface code-17 processor in the near-FTQC era shown in FIG. 17, qubits shared in the same frequency group are shown in the same style, and frequency relationships between qubits are f₁>f₂>f₃.

The qubit allocation device uses a frequency flag for each physical qubit. In the frequency scheduling process, the qubit allocation device may initialize all flags to −1 and then update the flags according to the states of the flags.

For example, flags may be updated first in the current time-step according to states of physical qubits, and then frequency information may be updated in order of two-qubit gates with higher priority and single-qubit gates. As an example, frequency flags associated with the second frequency f₂ and the third frequency f₃ for executing a two-qubit gate may be updated, and then the first frequency f₁ associated with a single-qubit gate may be updated.

Therefore, when frequency constraints for the frequency scheduling process are satisfied in the frequency scheduling process, the qubit allocation device may schedule the execution of a corresponding gate. When the above procedure is completed, only the scheduled gate may be executed.

As described above, dynamic scheduling may include two steps duration scheduling and frequency scheduling (see Algorithm 3).

In the duration scheduling phase, it is determined whether the gate gₛₐₜ which satisfies the connectivity constraint is executable in a current time step. To this end, a duration flag may be introduced for each logical qubit. When the duration flag is 0, the corresponding qubit is not allocated for gate execution. Accordingly, duration scheduling is possible only when the duration flags of both a control qubit and a target qubit are 0. After that, a longer duration is necessary, and thus higher priority is given to two-qubit gates than single-qubit gates. Therefore, a gate having the longest critical path may have priority among the same type of gates. After this process, only the gates gₜₑₘₚ without temporal constraints may be left.

In the case of frequency scheduling through the gates gₜₑₘₚ without temporal constraints, a frequency flag is introduced in a manner similar to duration scheduling and defined for a physical qubit. In other words, the qubit allocation device may initialize all frequency flags to −1 and then update flags according to the corresponding states of physical qubits. two-qubit gates may be scheduled first according to the priority order of the gates gₜₑₘₚ without temporal constraints using frequency adjustment rules.

A two-qubit gate may be executed only when a frequency flag is 0 or 1 and all adjacent qubits satisfy frequency constraints. When a frequency violation occurs due to a previously scheduled qubit, the corresponding gate is currently not schedulable. In the case of a single-qubit gate, only the same type of gates are executable in the same frequency group. Accordingly, the qubit allocation device may create a first record, designate a gate type of a frequency group, and update a frequency flag. Then, the qubit allocation device may compare gate types of subsequent gates with the frozen information and then schedule only currently executable gates. When this process is completed, the qubit allocation device may return the scheduled gate g_{scheduled} that satisfies all constraints. In other words, like in Algorithm 2, when all gates are executed, the qubit allocation device may return a final circuit.

A post-processing phase for additionally reducing latency through quantum circuit optimization (QCO) will be described below.

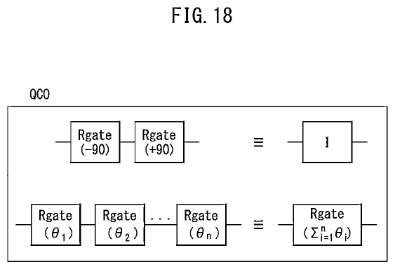

FIG. 18 is a diagram illustrating a QCO module that may be employed in the post-processing phase of the qubit allocation method of FIG. 4.

Referring to FIG. 18, the qubit allocation method may be configured to further reduce the latency of a final circuit through QCO. The purpose of QCO is to generate a circuit that is logically identical to the original circuit but is much less expensive. According to a QCO method, only a simple optimization technology is applicable to single-qubit gates to avoid consuming much time.

Here, a single-qubit gate may include an RX(θ) gate and an RY(θ) gate which are rotation operators. These rotation operators function to rotate a state of a qubit by a certain angle θ about each axis. Accordingly, two R-gates having different signs about the same axis may be converted into an identity gate. Also, consecutive RX gates or RY gates may be replaced with a single operator in which the sum of angles of gates forms a new angle. In this way, according to the QCO method, the latency of a final circuit can be additionally reduced through an optimization process after qubit allocation.

The foregoing post-processing phase may also be used as a pre-processing phase that is performed before the initial mapping phase. In other words, according to the qubit allocation method, the latency of a final circuit obtained through a mapping phase can be further reduced through two circuit optimization processes in a pre-processing phase and a post-processing phase.

The foregoing MCQA may be implemented in the programming language C++ and compiled using the GNU compiler collection (GCC), for example, GCC version 8.1.0. α=0.9 and β=3.0, which are variables for executing MCQA, may be obtained through a preliminary experiment and used. Benchmark circuits obtained from RevLib and QLib may be used in an experiment for performance assessment. Also, the surface code-17 processor may be set as the target hardware to perform qubit allocation. A mapping experiment may be performed on a server equipped with Intel Xeon Skylake processors (52 logical cores) and a 490 GB random access memory (RAM). An operating system (OS), such as CentOS 7.9 or the like, may be used on the server.

TABLE 1A
w/o frequency matching

| Benchmarks | #SW | #MV | #BR | #CZ | LT | RT |
|---|---|---|---|---|---|---|
| alu-bdd_288 | 3 | 0 | 12 | 45 | 219 | 0 |
| sym6_145 | 259 | 8 | 462 | 2,179 | 9,619 | 0.1 |
| life_238 | 1,283 | 35 | 2,769 | 12,226 | 52,518 | 0.55 |

TABLE 1B
w/ frequency matching

| Benchmarks | #SW | #MV | #BR | #CZ | LT | RT |
|---|---|---|---|---|---|---|
| alu-bdd_288 | 3 | 0 | 12 | 45 | 216 | 0.01 |
| sym6_145 | 221 | 13 | 441 | 2,012 | 9,428 | 0.1 |
| life_238 | 1,273 | 34 | 2,749 | 12,134 | 52,415 | 0.55 |

Table 1A and Table 1B show experiment results of a qubit allocation method according to whether frequency matching is performed. In other words, to verify the effects of the initial mapping phase based on frequency awareness, Table 1A and Table 1B show experiment results on the performance difference according to whether frequency matching is performed.

In Table 1, #SW, #MV, #BR, and #CZ represent the numbers of added swap gates, move gates, bridge gates, and CZ gates, respectively. LT represents the latency of the quantum circuit, and RT represents the runtime of qubit mapping.

In an alu-bdd_288 benchmark circuit, when the number of additional CZ gates has already been optimized through a graph isomorphism search, the latency of the circuit may be further reduced using frequency matching. This is so that a cost function for selecting an optimal frequency-matched layout from among candidate graphs predicts the maximum parallelism of gate execution well. Since frequency matching is performed through a very small number of searches, a runtime increases by only 0.01 seconds compared to a case where frequency mapping is not used. In the case of two other benchmarks, gate overhead is reduced through frequency matching. Even in the case of isomorphic layout graphs, the number of additional gates and the latency can be reduced by increasing the parallelism of gate execution. Therefore, Algorithm 1 for initial mapping can rapidly generate a layout for simultaneously reducing the number of additional gates and latency.

In the surface code-17 processor, the number of physical qubits is limited. Accordingly, when the size of the benchmark circuit increases, available space is reduced. However, when the processor further increases in size, it is expected that the proposed frequency-aware graph matching completely will cover all frequency patterns and latency can be further reduced.

Qubit mapping experiment results will be illustrated according to the steps of the main mapping. The qubit mapping experiment results are shown in Table 2. The qubit mapping experiment results are obtained by normalizing the final results.

TABLE 2

| Gate | | | Scheduling | | QCO | | Avg. overhead | |
|---|---|---|---|---|---|---|---|---|
| SW | MV | BR | Duration | Freq. | Pre | Post | Gate | Latency |
| √ | — | — | √ | √ | √ | √ | 1.62 | 1.22 |
| √ | — | √ | √ | √ | √ | √ | 1.02 | 1.01 |
| √ | √ | — | √ | √ | √ | √ | 1.57 | 1.19 |
| √ | √ | √ | — | √ | √ | √ | 1.00 | 1.04 |
| √ | √ | √ | √ | √ | — | — | 1.00 | 1.51 |
| √ | √ | √ | √ | √ | — | √ | 1.00 | 1.01 |
| √ | √ | √ | √ | √ | √ | — | 1.00 | 1.36 |
| √ | √ | √ | √ | √ | √ | √ | 1.00 | 1.00 |

Referring to results obtained by analyzing each step of main mapping in terms of overhead in Table 2, when qubit allocation is performed using Algorithm 1 for initial mapping and Algorithm 2 for main mapping, Algorithm 2 may be configured to satisfy the connectivity constraint using swap, move, and bridge gates.

Here, the move gate employs a smaller number of CNOT gates than the number of swap gates. Accordingly, when swap gates are used together with move gates, gate overhead can be reduced by about 3% on average compared to a case where only swap gates are used. However, since the number of auxiliary qubits is reduced in a layout with an increase in the number of logical qubits, a gate overhead reduction ratio resulting from move gates is not large. Accordingly, the qubit allocation device resolves the connectivity problem using bridge gates together with move gates without changing a layout. As a result, in the qubit allocation device, the number of CZ gates can be significantly reduced using bridge gates. Here, the qubit allocation device can effectively select gates to be used in a quantum circuit through the heuristic cost function and the parameters a and B.

Also, the qubit allocation device can reduce latency through dynamic scheduling in each current time step. Latency overhead can be reduced by 4% on average through duration scheduling. This result shows that the method of determining the priority order of gates through the qubit-based gate dependency list is effective. Also, the latency can be further reduced using simple QCO before and after qubit allocation. Therefore, with the qubit allocation method of maximizing parallelism between gates according to the present embodiment, it is possible to generate a final circuit in which the latency is effectively reduced while connectivity is satisfied.

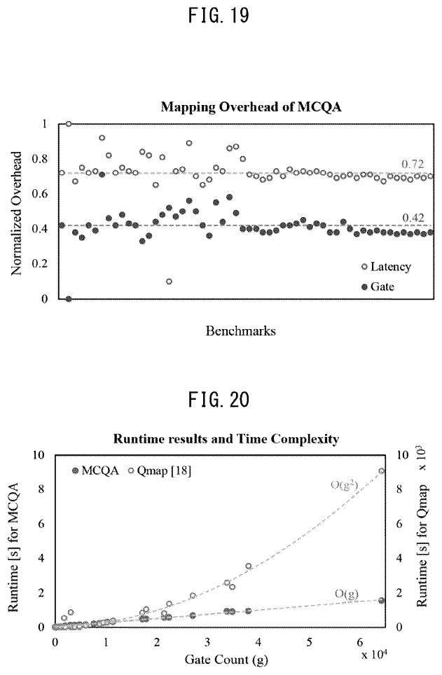

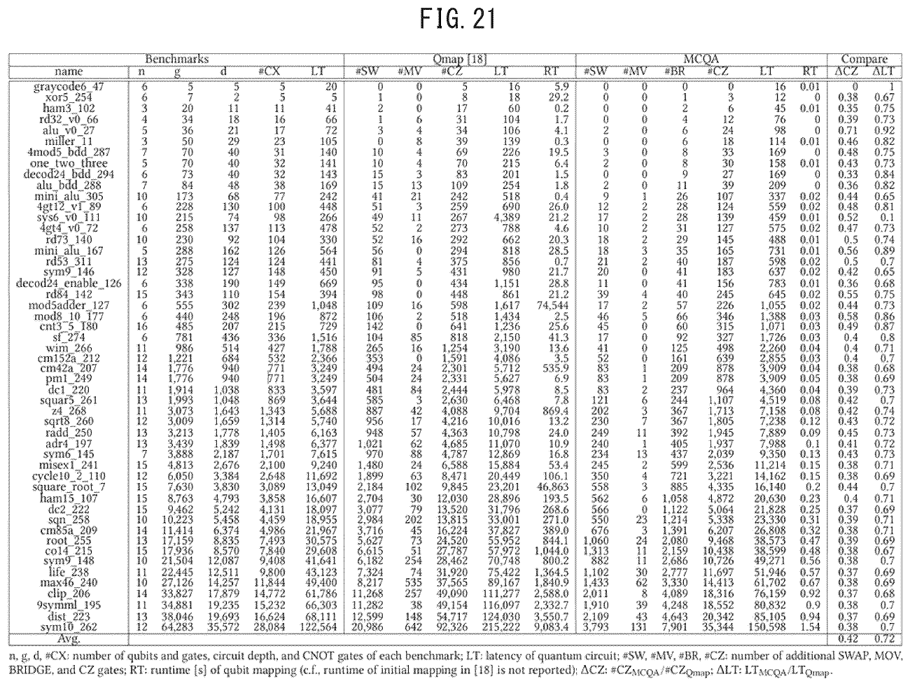

FIG. 19 is a graph showing mapping overhead comparison results between the qubit allocation method of the present embodiment and a comparative example Qmap. FIG. 20 is a graph showing runtime performance comparison results between the qubit allocation method of the present embodiment and the comparative example. FIG. 21 is a table showing mapping overhead and runtime values of comparative experiment results of FIGS. 19 and 20.

Referring to FIG. 19, mapping overhead values of MCQA after qubit allocation were normalized with respect to a timing and resource-aware mapper of the comparative example Qmap and displayed. The horizontal dashed lines represent average overhead values, and benchmarks are displayed on the horizontal axis in an order shown in the table of FIG. 21.

In other words, to verify a mapping overhead reduction through the mapping methodology of the qubit allocation method of the present embodiment, a comparative experiment was conducted with the comparative example Qmap. The table of FIG. 21 shows the number of added CZ gates and a circuit latency after qubits are allocated to the surface code-17 processor. FIG. 19 shows mapping overhead values of the benchmark circuits and an average value, and each value was normalized with respect to a result of Qmap. As a result, the mapping methodology of the present embodiment can reduce gate overhead by 58% on average compared to the methodology of the comparative example Qmap. This result shows that the initial mapping solution based on graph matching satisfies the interaction between two qubits in the overall circuit. The heuristic function used in the main mapping phase of the present embodiment to reduce gate overhead can be used in selecting an appropriate gate between a swap gate and a move gate. Also, it is possible to effectively resolve the connectivity constraint without excessively changing the layout of a quantum circuit by additionally using a bridge gate.

Further, the mapping methodology of the present embodiment reduced a circuit latency by 28% on average compared to the mapping methodology of the comparative example. This is because higher parallelism was achieved between gates being executed despite QCO not being performed during mapping. In other words, a frequency pattern search increases the possibility of parallel gate execution even when layout graphs have the same shape. Further, a qubit-based gate list can provide immediate feedback for a critical path in each time step. In this way, dynamic scheduling in the mapping method of the present embodiment effectively reduces circuit latency.

FIG. 20 shows runtime results and time complexity of MCQA of the present embodiment and Qmap[18] of the comparative example according to a benchmark size. In the graph of FIG. 20, the vertical axis on the left side represents a runtime of MCQA, and the vertical axis on the right side represents a runtime of Qmap. The dashed lines represent the time complexity of the methodologies. In other words, the time complexity of MCQA of the present embodiment was O(g), and the time complexity of Qmap[18] of the comparative example was O(g²).

In the comparison between the latest mapping methodology of the comparative example Qmap[18] and the mapping methodology of the present embodiment based on the scalable surface code-17 processor, benchmark circuits were decomposed into the same primitive gate set including RX, RY, and CZ gates for a fair comparison, and durations were calculated in the same manner. Also, the qubit allocation device of the present embodiment employed initial mapping and main mapping and performed QCO before and after mapping.

Further, runtimes required for MCQA of the present embodiment and Qmap[18] of the comparative example to perform overall qubit mapping were compared with each other. The table of FIG. 21 shows runtimes of overall qubit mapping including the optimization phase. Here, Qmap of the comparative example limited the time for searching for an initial mapping to 10 minutes and did not reflect the time on a final execution time of a central processing unit (CPU) or a processor.

As per experiment results, the runtime of the mapping methodology of the present embodiment was reduced by 99% on average compared to the Qmap of the comparative example. This is because the graph-matching method of the present embodiment can efficiently perform initial mapping with lower time complexity than the method of the comparative example. It is also because an optimal frequency pattern for the initial layout can be determined through only a few searches by previously analyzing surface code. Further, the qubit mapping method of the present embodiment can rapidly determine the order of gates to be executed through a qubit-based search and execute the scheduled gates in the main mapping phase. In addition, the qubit allocation device of the present embodiment additionally employs a QCO method, and thus it is possible to obtain a final circuit that is simple enough to not affect a qubit allocation time.

Meanwhile, as shown in FIG. 20, the time complexity of the two mapping methods of the present embodiment and the comparative example may be compared with each other to analyze scalability. Although outliers of square_root_7 were omitted among Qmap analysis results of the comparative example in the drawing, Qmap of the comparative example has polynomial time complexity relative to the number of gates constituting a benchmark circuit. On the other hand, it is possible to see that MCQA of the present embodiment achieves linear time complexity according to the number of gates. Also, a runtime of MCQA of the present embodiment can be scaled down by a factor of about 1,000 compared to that of Qmap of the comparative example. This result implies that MCQA which is the qubit allocation method of the present embodiment can have high scalability for larger hardware and circuits of the full FTQC era.

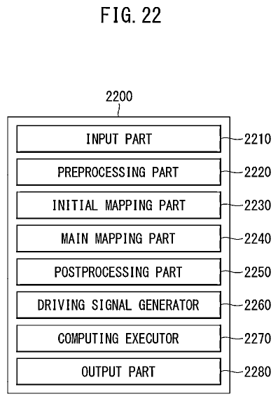

FIG. 22 is a schematic block diagram of a quantum apparatus employing a qubit allocation method according to another example embodiment of the present invention.

Referring to FIG. 22, a quantum apparatus 2200 may include an initial mapping part 2230 and a main mapping part 2240 as a qubit mapping framework. Also, the quantum apparatus 2200 may further include at least one of a pre-processing part 2220 and a post-processing part 2250. The quantum apparatus 2200 may be configured to further include an input part 2210, a driving signal generator 2260, a computing executor 2270, a result output part 2280, or a combination thereof. In addition, the quantum apparatus 2200 may include an algorithm decomposition part installed between the input part 2210 and the pre-processing part 2220.

The quantum apparatus 2200 may be connected to at least one of an additional digital processor and memory system. In the memory system, a program, quantum assembly code, a quantum circuit mapping result, and the like for a quantum apparatus may be stored.

Each component will be described in detail. First, the input part 2210 may externally receive at least one of a signal and data of a quantum algorithm and target hardware. The quantum algorithm may be described by at least one quantum circuit.

The algorithm decomposition part may decompose the quantum circuit so that one logical qubit corresponds to at least one physical qubit.

The pre-processing part 2220 may be configured to optimize the quantum circuit to further reduce latency.

The initial mapping part 2230 may be configured to perform initial mapping on the basis of frequency-aware graph matching. The initial mapping part 2230 may be referred to as a device for performing initial mapping which has been described in detail above with reference to FIG. 7 and the like or a constituent part for performing a function corresponding to the device.

The main mapping part 2240 may be configured to achieve maximum parallelism between gates when the connectivity constraint is resolved. The main mapping part 2240 may be referred to as a device for performing the main mapping which has been described in detail above with reference to FIG. 12 and the like or a constituent part for performing a function corresponding to the device.

The post-processing part 2250 may optimize the quantum circuit by further reducing the number of single-qubit gates. Accordingly, mapping quality is improved, and the latency can be further reduced.

The driving signal generator 2260 may generate a driving signal for performing quantum computation for a final circuit obtained according to a mapping result or a final circuit obtained as a result of mapping and post-processing.

In response to the driving signal, the computing executor 2270 may perform quantum computation for a final circuit obtained according to the mapping result or post-processing optimization.

The output part 2280 may output a computation result of the computing executor 2270 in the form of a preset signal of data.

According to the quantum apparatus of the present embodiment, it is possible to effectively perform qubit allocation for resolving multiple constraints, that is, MCQA, through an efficient multi-constraint qubit allocation method in which near-FTQC hardware is taken into consideration. In particular, an initial mapping for reducing both the number of additional gates and the latency can be generated using frequency-aware graph matching, and it is possible to resolve the connectivity constraint by selectively using three additional gates in a main mapping phase and achieve maximum parallelism using dynamic scheduling. As a result, the latency and the number of necessary additional gates can be effectively reduced. Also, compared to a comparative example that employs a related mapping methodology, MCQA of the present embodiment can reduce the number of additional CZ gates, the latency, and runtime by 58%, 28%, and 99%, respectively. Further, it is possible to provide higher scalability by achieving linear time complexity according to the number of gates.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus that is specifically configured to store and execute a program command, such as a ROM, RAM, or flash memory. The program command may include not only machine language codes created by a compiler but also high-level language codes that can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer, or an electronic circuit. In some embodiments, one or more of the most important steps of the method may be executed by such an apparatus.

In some exemplary embodiments, a programmable logic device such as a field-programmable gate array may be used to perform some or all of the functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A multi-constraint qubit allocation (MCQA) method for a scalable quantum apparatus, the MCQA method comprising:
generating an interaction graph representing a quantum circuit on the basis of the number of two-qubit gates;
determining edge weights between connected nodes in the interaction graph by introducing a fitting coefficient for a decay effect;
searching for an isomorphic part, which is a layout graph, between a target hardware and the interaction graph by graph matching; and
performing frequency matching for a layout graph by searching for frequency patterns allocated to each location of qubits by limiting unidirectional movement on each of an x-axis and a y-axis of a hardware plane of the target hardware to a range from −1 to +1.

2. The MCQA method of claim 1, wherein the searching for the isomorphic part comprises repeatedly searching for physical locations of logical qubits of the quantum circuit in descending order of edge weight.

3. The MCQA method of claim 1, wherein the searching for the isomorphic part comprises repeatedly searching for physical locations of child nodes connected to a logical center node of a breadth-first search queue.

4. The MCQA method of claim 1, wherein the performing of the frequency matching comprises additionally considering a layout graph which is symmetrical to the layout graph about the y-axis of the hardware plane.

5. The MCQA method of claim 1, wherein the performing of the frequency matching comprises calculating a frequency allocated to each location of qubits based on the frequency period by repeating the arrangement of each frequency pattern.

6. The MCQA method of claim 5, further comprising predicting a degree of parallelism of gates which are executable for all graphs obtained from searching for frequency patterns allocated to each location of qubits.

7. The MCQA method of claim 1, further comprising determining an order of gates to be executed in a main mapping.

8. The MCQA method of claim 7, wherein the determining of the order of the gates to be executed comprises determining the order of the gates to be executed using a qubit-based gate dependency list for the quantum circuit,
the gate dependency list, having connection lists with the same number as logical qubits, may include indices of gates and durations of the gates, and
the connection lists represent topological relationships between gates in the corresponding qubits.

9. The MCQA method of claim 8, further comprising, when at least one gate of the quantum circuit does not satisfy a connectivity constraint, adding a swap gate or a move gate in front of the gate not satisfying the connectivity constraint.

10. The MCQA method of claim 9, further comprising selecting a gate, either a swap gate or move gate, having a higher one of costs calculated for all candidate swap gates and move gates.

11. The MCQA method of claim 9, further comprising, when at least one gate of the quantum circuit does not satisfy the connectivity constraint, converting the gate not satisfying the connectivity constraint into a bridge gate.

12. The MCQA method of claim 11, wherein the bridge gate has a physical distance of 2.

13. The MCQA method of claim 7, further comprising determining whether scheduled gates in the quantum circuit including the gates of which the order is determined are executable in a current time step.

14. The MCQA method of claim 13, further comprising, when a frozen duration (FD) flag introduced to each logical qubit is 0, indicating that the corresponding qubit is not currently executing any scheduled gates, processing the corresponding qubit as the current scheduled gate, allowing it to proceed to the next gate execution.

15. The MCQA method of claim 13, further comprising giving relatively high priority to two-qubit gates among the scheduled gates.

16. The MCQA method of claim 13, further comprising giving relatively high priority to a gate having the longest critical path among the same type of gates in the scheduled gates.

17. The MCQA method of claim 13, further comprising initializing frozen frequency (FF) flags introduced for physical qubits of quantum hardware to −1 and updating the FF flags according to frequency states.

18. The MCQA method of claim 17, further comprising scheduling a two-qubit gate which is selected according to a priority of the FD flags, according to preset frequency adjustment rules.

19. The MCQA method of claim 18, wherein the scheduling of the single-qubit gate comprises:
recording a first gate type of each frequency group;
updating the FF flags for all qubits belonging to the same frequency group;
comparing subsequent gates with the previously recorded gate type to determine whether the subsequent gates are of the previously recorded gate type and whether the FF flags are correctly set; and
scheduling only executable gates according to determination results.

20. The MCQA method of claim 7, further comprising, before the generating of the interaction graph on the basis of the number of two-qubit gates, pre-processing an input or, after the main mapping, post-processing main mapping results,
wherein the pre-processing of the input or the post-processing of the main mapping results comprises converting two rotation operators applied to single qubits having different signs about the same axis of the Bloch sphere into an identity gate; or replacing consecutive rotation operators with a single rotation operator in which a sum of angles of gates forms a new angle.
